(19) United States
(12) Patent Application Publication
(10) Pub. No.: US 2016/0089774 A1
(43) Pub. Date: Mar. 31, 2016

(54) HANDHELD ENGAGEMENT DEVICE

(71) Applicant: Matthew Peter COTTAM, Staffordshire (GB)

(72) Inventor: Matthew Peter Cottam, Staffordshire (GB)

(21) Appl. No.: 14/892,756

(22) PCT Filed: May 1, 2014
(86) PCT No.: PCT/GB2014/051352

§ 371 Date: Nov. 20, 2015

(30) Foreign Application Priority Data
May 21, 2013 (GB) 1309101.2

(51) Int. Cl. B25J 1/00; E05B 1/00

(52) U.S. Cl. CPC B25J 1/00; E05B 1/0069

(57) ABSTRACT

A handheld engagement device (10) comprising first and second planar flexible members (12) interconnected at each end by hinge arrangements (14). Cut outs (18, 26) are provided in side edges of the flexible members (12). The flexible members (12) can be bowed outwardly by pressing together on the hinge arrangements (14) to enable engagement with an item such as a handle.

This invention concerns a handheld engagement device, and particularly but not exclusively such a device which enables a user to operate a number of mechanisms such as door knobs, handles, latching and locking mechanisms, keys and buttons, without making actual physical contact with the mechanisms.

During the course of repeated use many hand-operated mechanisms accumulate harmful bacteria and other “germs”. In the absence of suitable hygienics, and/or effective cleaning, the surfaces of these mechanisms have the potential to transfer such disease agents from one operator to another. Commonly contaminated examples of hand-operated mechanisms include toilet flushes, door locks and handles, faucets and ATM buttons. In the case of public toilets, exiting is often via a door equipped with a hand-operated handle, which forces patrons to touch a mechanism used by others, including those who may not have followed sanitary protocol.

According to the present invention there is provided a handheld engagement device, the device including first and second generally planar flexible members, the members being configured to in a rest condition overlie each other, the members being interconnected at respective opposite ends and configured such that when a compressive force is applied between the opposite ends, the planar members will respectively bow outwardly, thereby defining a space therebetween in which an item can be engaged.

The flexible members may be made of a plastics material.

The flexible members may be made of a shape memory material, and may be made of a shape memory polymer or metal.

The device may be formed from an antibacterial and/or disease inhibiting material, or may be provided with a coating of an antibacterial and/or disease inhibiting material. The material or coating may include copper and/or silver.

A hinge formation may be provided at each respective opposite end of the formation.

The device may be integrally formed, with a formation provided between the flexible members, which formation may be a fold, and may comprise a line of reduced thickness material.

The flexible members may have a similar profile to each other so as to substantially wholly overlie each other when the device is in the rest condition.

The flexible members may have a generally rectangular configuration.

Parts of the flexible members may have a greater thickness to provide additional strength. Parts of the flexible members adjacent the hinge formation may have a greater thickness relative to the remainder of the flexible members.

The flexible members may be profiled so as to define a side recess in side edges thereof, which side recess can receive part of an item to enable engagement with the item.

The formations may be profiled so as to define a corner recess in a side edge adjacent an interconnected end, which corner recess can receive part of an item to enable engagement therewith.

A straight side edge may be provided on the flexible members between the side and corner recesses, which side edge is engageable with control buttons to operate same, and may be of a size to be engageable with a single control button at a time.

Inner surfaces of the flexible members may be profiled so as to facilitate gripping of an item. Outer surfaces of the flexible member may be profiled to facilitate holding of the device, and selective parts only of the outside surfaces of the device may be profiled.

A clip may be provided on the device to permit mounting on an item or on clothing. The clip may comprise a resilient member defining a variable size gap between the clip and the outer side of a one of the flexible members, in which gap an item or an article of clothing can be gripped.

The clip may be removably mounted on the remainder of the device.

A magnet configuration may be provided to urge the flexible members together when in a rest condition.

A formation may be provided on the device to receive a line means to enable the device to be carried around a person's neck or to be secured to another device.

An embodiment of the present invention will now be described by way of example only and with reference to the accompanying drawings, in which:

FIG. 1 is a diagrammatic first side view of a device according to the invention;

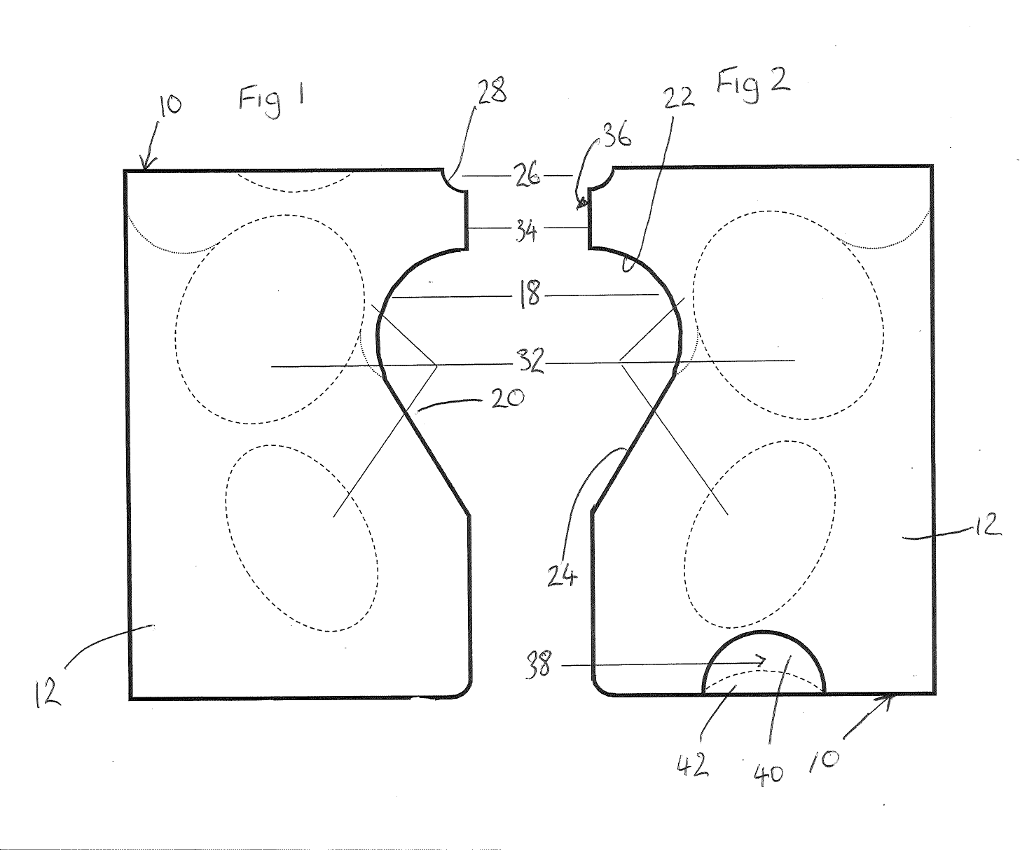

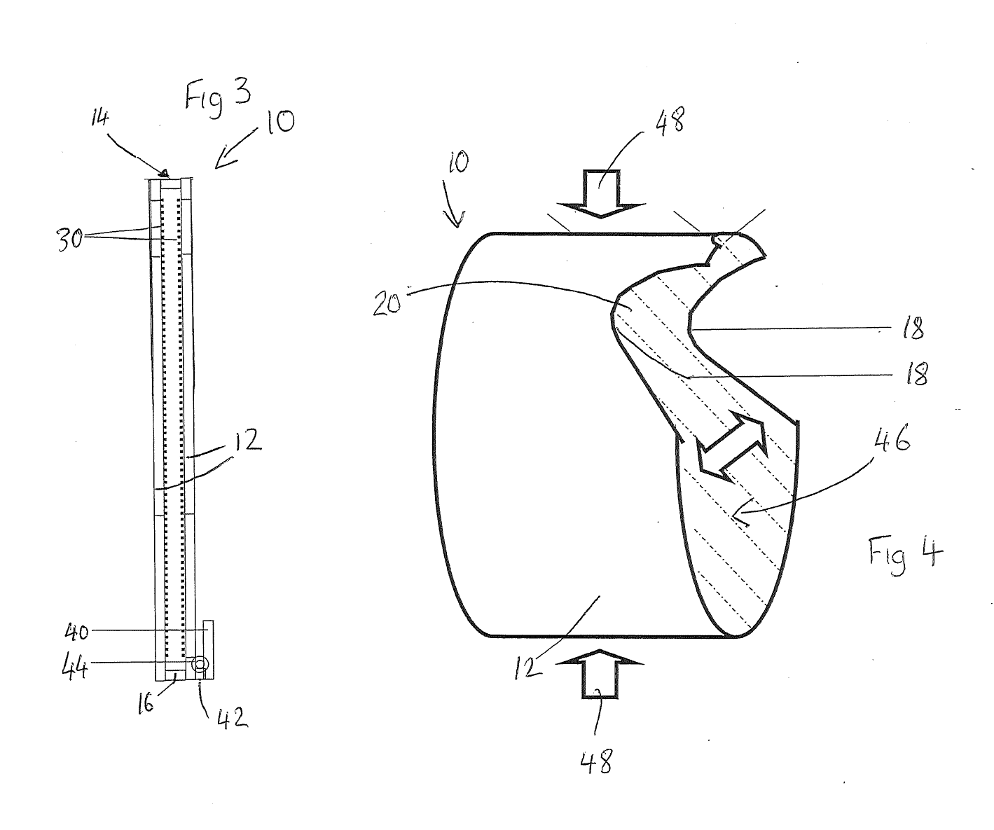

FIG. 2 is a diagrammatic second side view of the device of FIG. 1;

FIG. 3 is a diagrammatic end view of the device of FIG. 1;

FIG. 4 is a diagrammatic perspective view of the device of FIG. 1 moved from a rest condition;

FIG. 5 is a diagrammatic perspective view showing use of the device of FIG. 1 to open a handle;

FIG. 6 is a diagrammatic perspective view showing use of the device of FIG. 1 in operating a latch;

FIG. 7 is a diagrammatic perspective view of the device of FIG. 1 being used to operate a bolt mechanism;

FIG. 8 is a diagrammatic perspective view showing use of the device of FIG. 1 to operate a faucet;

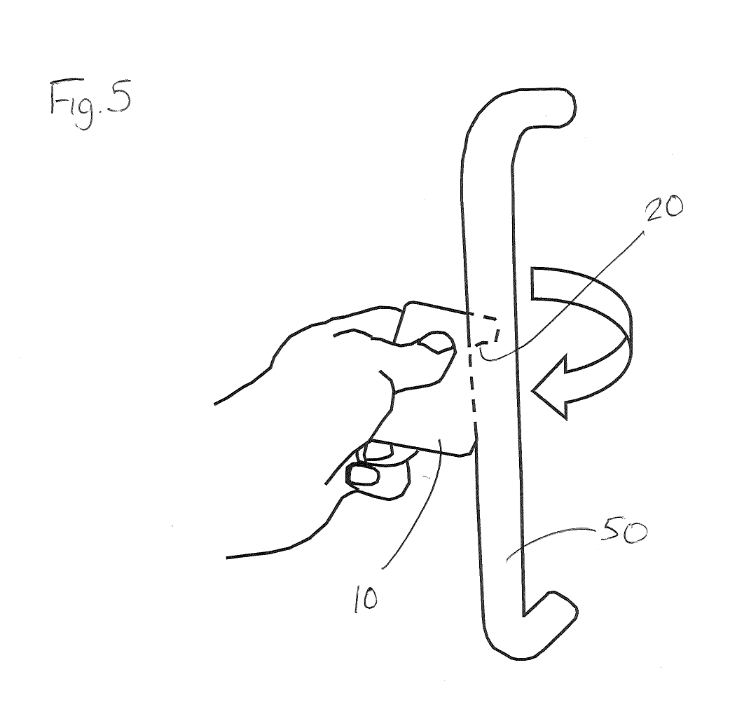

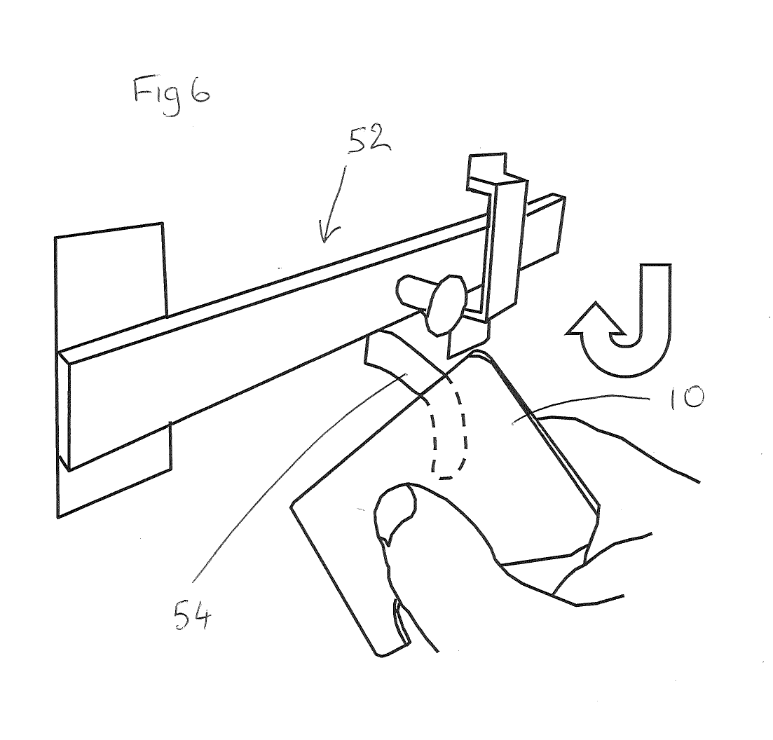

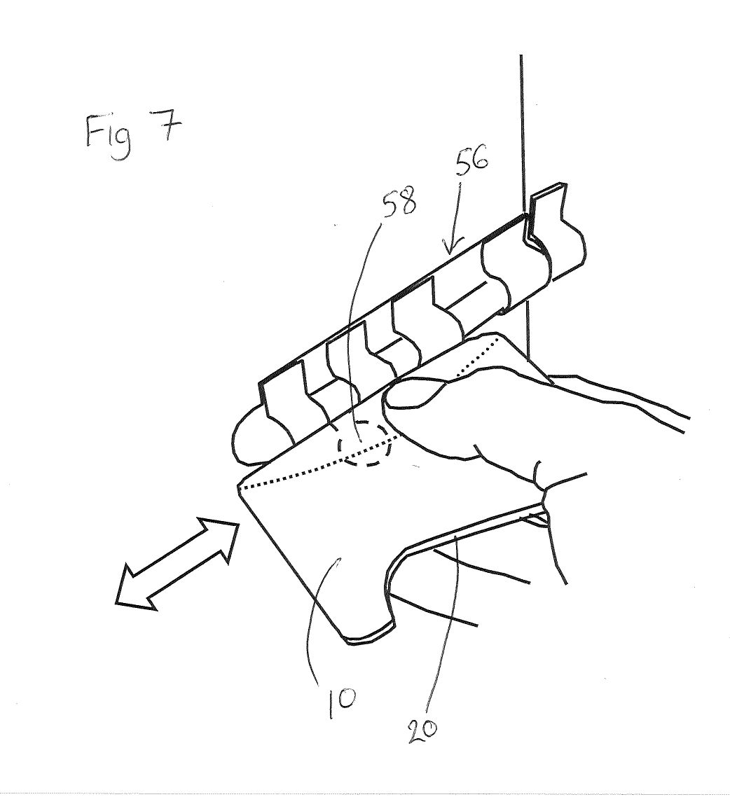

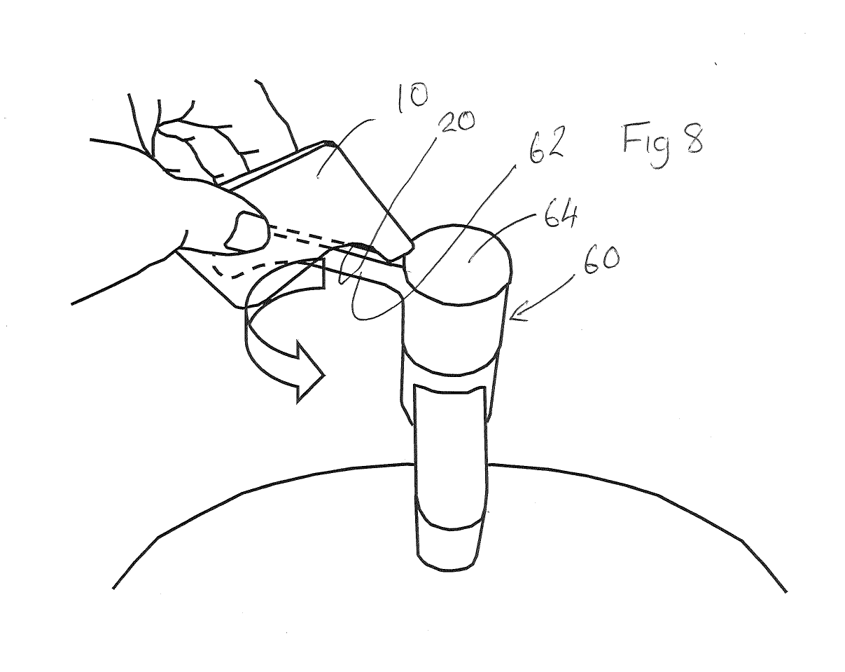

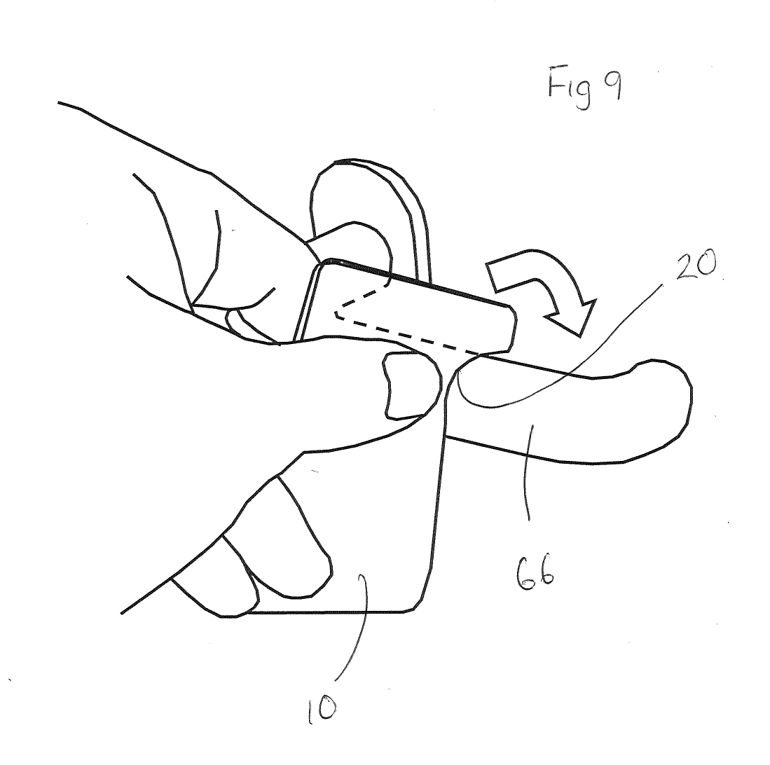

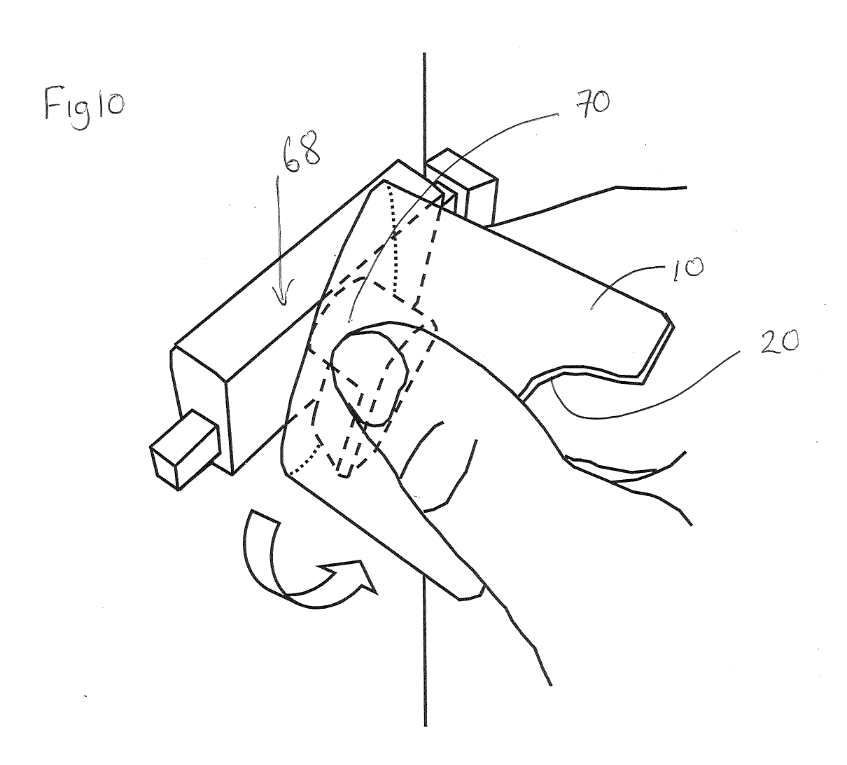

FIG. 9 is a diagrammatic perspective view showing use of the device of FIG. 1 in operating a handle;

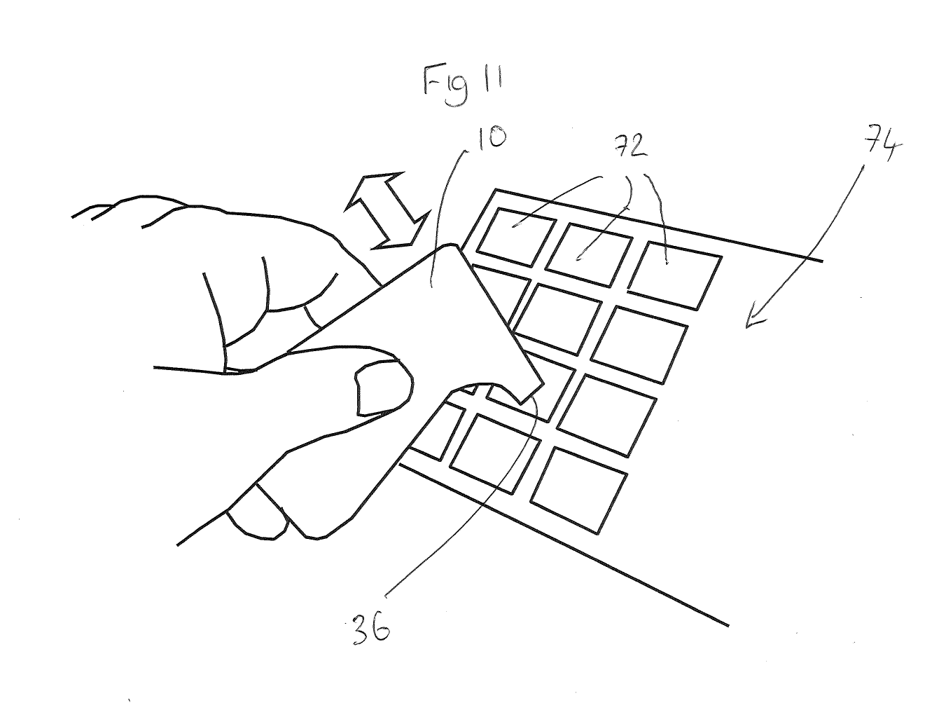

FIG. 10 is a diagrammatic perspective view showing use of the device in FIG. 1 in operating a lock;

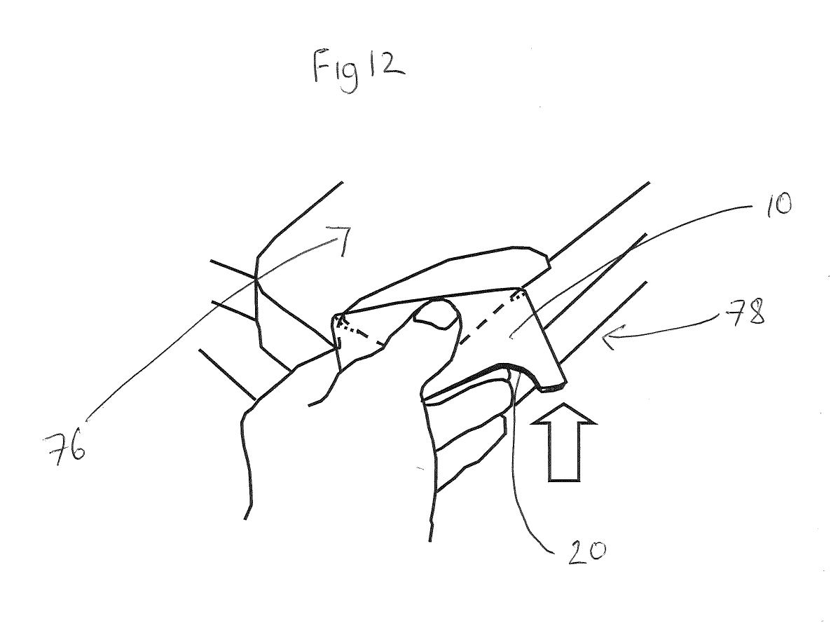

FIG. 11 is a diagrammatic perspective view showing use of the device of FIG. 1 in operating control buttons;

FIG. 12 is a diagrammatic perspective view showing use of the device of FIG. 1 in opening the lid of an item;

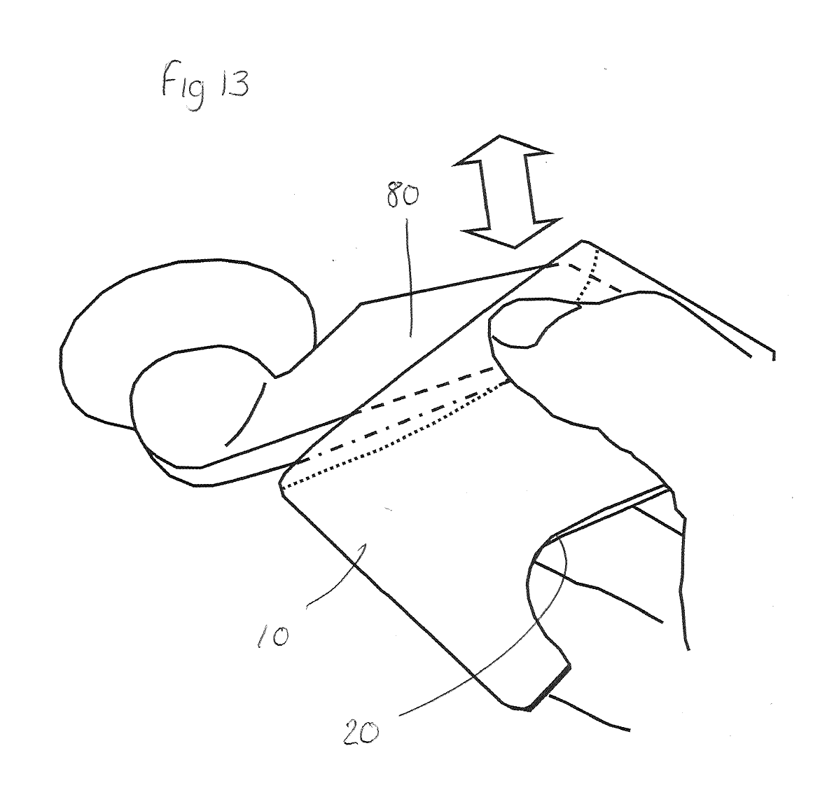

FIG. 13 is a diagrammatic perspective view showing use of the device of FIG. 1 in operating a toilet flush;

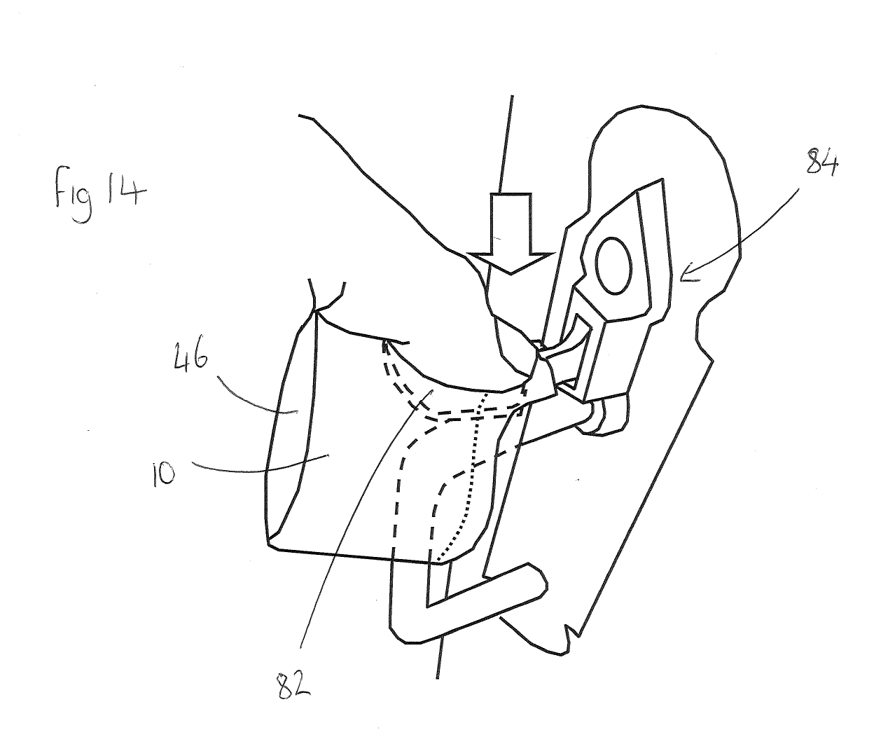

FIG. 14 is a diagrammatic perspective view showing use of the device of FIG. 1 in operating a thumb latch;

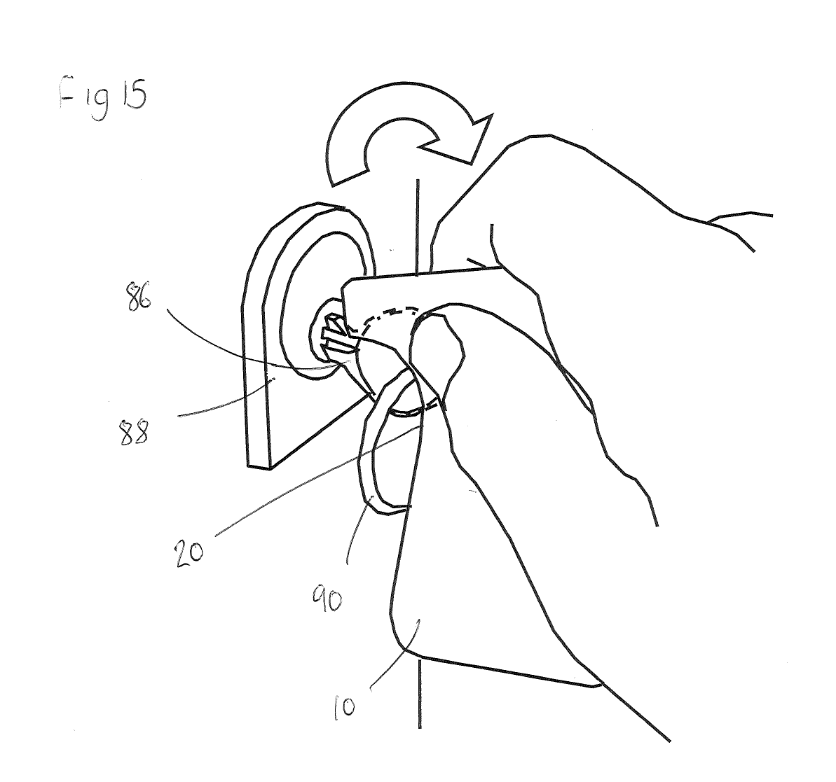

FIG. 15 is a diagrammatic perspective view showing use of the device of FIG. 1 in operating a key in a latch;

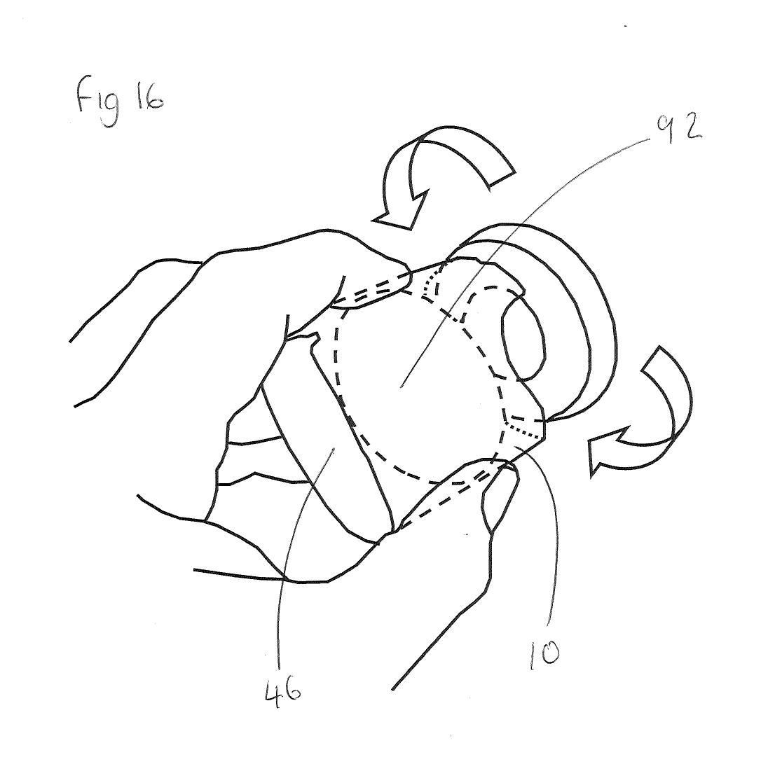

FIG. 16 is a diagrammatic perspective view of the device shown in FIG. 1 used to turn a door knob; and

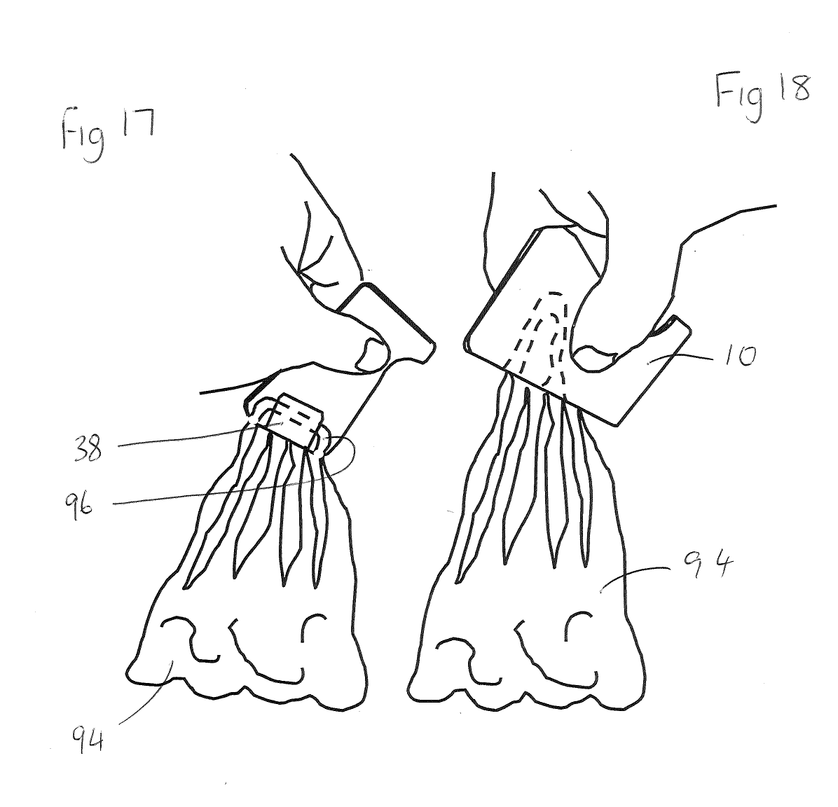

FIGS. 17 and 18 are diagrammatic side views showing use of the device of FIG. 1 being used to carry an item by two respective methods.

The drawings show a handheld engagement device 10 suitable for a wide range of operating, gripping and handling applications as hereinbefore described.

The device 10 comprises first and second planar flexible members 12 with a similar profile. The flexible members 12 are interconnected at each end by a hinge arrangement 14 in the form of a strip 16 of material located between the flexible members 12 at respective ends thereof.

The flexible members 12 have a generally rectangular configuration with the hinge arrangements 14 provided along shorter sides of the rectangles. A cut out 18 is provided in a side edge of each of the flexible members 12 to define a side recess 20. The cut out 20 is towards the upper end of the flexible members 12 as shown in FIGS. 1 and 2 and has a generally upper portion curved 22 extending into a linear portion 24 extending back to the side edge of the flexible member 12 below a mid point thereof.

A corner recess 26 is provided by an arcuate cut out 28 in the corner of the flexible members 12 above the side recess 20 shown in FIGS. 1 and 2. A gripping formation 30 is provided on inner sides of the flexible members 12. Areas 32 of contouring are provided on parts of the outer faces of the flexible members 12 to aid grip therewith by a user. A straight edge 34 is provided between the side and corner recesses 20, 26. The straight edge 34 defines in use a button engagement part 36.

A clip 38 is provided midway along a lower edge as shown in FIG. 2 of a one of the flexible members 12. The clip 38 is in the form of a resilient semi-circular member 40 spaced from the respective flexible member 12 by a spacer strip 42. An opening 44 may be provided in the strip 42 to permit a lanyard or other line means to extend therethrough to enable the device 10 to be worn around a person's neck, or be secured to another device.

In many operations of the device 10 it is required for the flexible members 12 to be urged apart to a gripping space 46 therebetween. FIG. 4 shows such an arrangement where a compressive force is applied on each of the hinge arrangements 14 as shown by the arrows 48, causing the flexible members 12 to bow outwardly thereby defining the gripping space 46.

FIG. 5 shows the device 10 being used to open a generally C shaped handle 50, as may be provided on a door or cupboard etc. The device 10 is inclined relative to the handle 50 with the handle engaging in the side recess 20 such that the handle 50 can be moved by movement of the device 10, without a user actually touching the handle 50.

FIG. 6 shows the device 10 being used to operate a latch arrangement 52. The device 10 is opened by a compressive force applied to the hinge arrangements 14 to define a relatively small gripping space 46 in which a latch 54 of the arrangement 52 can be located. A user can then apply a force compressing the device 10 and thereby gripping the latch 54 between the flexible members 12 and enabling actuation thereof by the device 10.

FIG. 7 shows use of the device 10 to operate a bolt 56. Again the device 10 is opened to define a gripping space 46 which can receive the head 58 of the bolt 56. The device 10 can then be compressed onto the bolt head 56 in opening the bolt 54 to be slid as required. As can be seen in such an arrangement the side of the flexible members 12 opposite the side recess 20 is used.

FIG. 8 shows the device 10 being used to operate a faucet (water tap) 60. Again the device 10 is opened to define a gripping space 46 to locate on the faucet handle 62. In this arrangement the side of the device 10 with the side recess 20 is brought adjacent to the handle 60, and the side recess 20 enables the device 10 to engage closer to the head 64 of the faucet 60.

FIG. 9 shows the device 10 being used to operate a door handle 60. In this instance the flexible members 12 are held together, and the device is arranged with the door handle 66 locating in the side recess 20 such that the sides of the recess 20 engage against the handle 66.

FIG. 10 shows use of the device 10 to operate a lock 68. In this instance the device 10 is opened to define a gripping space 46 which can locate around a handle 70 of the lock 68. The device 10 is then closed around the handle 70 to permit twisting thereof. Here the side of the flexible members 12 without the side recess 20 engages against the lock 68.

FIG. 11 shows use of the device 10 being used to operate control buttons 72 for instance on an ATM machine 74. The device 10 is orientated such that the button engagement part 36 can engage with a required one of the buttons 72.

FIG. 12 shows the device being used to open the lid 76 for instance of a wheelie bin 78. Here the device 10 is opened a small amount to provide a gripping space 46 and the side of the device 10 without the side recess 20 is located across the corner of the lid 76. The flexible members 12 can now be urged together to engage the lid 76 and permit lifting thereof.

FIG. 13 shows the device 10 being used to operate the handle 80 of a lever toilet flush. The device 10 is opened up a certain amount with the side thereof without the side recess 20 engaging over the end of the handle 80.

FIG. 14 shows the device 10 being used to operate the movable handle 82 of a thumb latch arrangement 84. In this instance the device 10 is opened, and the corner recess 26 is located to engage with the mounting part of the handle 82, enabling the device 10 to be located close to the arrangement 84.

FIG. 15 shows the device 10 being used to turn a key 86 in a lock 88. The device 10 is opened sufficiently to engage with the key 86, with the side recess 20 adjacent the key so as to receive for example a key ring 90 as shown.

FIG. 16 shows the device 10 being used to turn a door knob 92. In this instance the device 10 is opened out to substantially define a circular section gripping space 46. The device 10 can then locate around the door knob 92 and then be urged thereonto by hand to permit turning of the knob 16.

FIG. 17 shows the device 10 being used to carry an item such as a bag 94 of dog excrement. In this instance a handle 96 on the bag is looped over the clip 38.

FIG. 18 also shows the bag 94 being carried by the device 10. In this instance though the handle 96 is gripped in the gripping space 46 and held therein by applying a force between the thumb and finger on the device 10.

There is thus described a device usable in a wide range of situations to permit engagement and operation of an item but without physical contact having to be made with a user's hands, thereby potentially spreading dirt, infection or disease. When not being used, the device can readily be carried in a pocket, wallet or purse, or worn on an item of clothing or carried elsewhere by virtue of the clip, or can be worn around a user's neck.

The device may be made for instance of a plastics material, and could for instance be integrally formed with the hinge arrangements being provided by reduced thickness lines in the material, or other formations. The device could be made of a shape memory material such as a polymer or metal.

The device may be made of an antibacterial and/or disease inhibiting material or provided with a coating of such a material.

A wide range of other modifications may be made without departing from the scope of the invention. For instance the device may take a different shape and may have different formations thereon or provided thereon in a different pattern. Different hinge arrangements can be used. Other or different recesses or projections may be provided on the device to enable engagement with other items. A clip and/or a lanyard opening may not be required.

Parts of the flexible members, such as for instance adjacent the hinge formations, may be of increased thickness to provide additional strength. Where rectangular, the device may have rounded and/or right angled corners as required. In some instances it may be that the two flexible members need not have exactly corresponding profiles.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A handheld engagement device, the device including first and second generally planar flexible members, the members being configured to in a rest condition overlie each other, the members being interconnected at respective opposite ends and configured such that when a compressive force is applied between the opposite ends, the planar members will respectively bow outwardly, thereby defining a space therebetween in which an item can be engaged.

2. The device according to claim 1, in which the flexible members are made of any of a plastics material, a shape memory material, a shape memory polymer or a shape memory metal.

3. (canceled)

4. (canceled)

5. The device according to claim 1, in which the device is formed from any of an antibacterial material, a disease inhibiting material, copper or silver.

6. (canceled)

7. The device according to claim 1, in which the device is provided with a coating, which coating includes any of an antibacterial material a disease inhibiting material, copper or silver.

8. (canceled)

9. The device according to claim 1, in which a hinge formation is provided at each respective opposite end of the formation.

10. The device according to claim 1, in which the device is integrally formed, with a formation provided between the flexible members.

11. The device according to claim 10, in which the formation is a fold.

12. The device according to claim 11, in which the formation comprises a line of reduced thickness material.

13. The device according to claim 1, in which the flexible members have a similar profile to each other so as to substantially wholly overlie each other when the device is in the rest condition.

14. The device according to claim 1, in which the flexible members have a generally rectangular configuration.

15. The device according to claim 1, in which parts of the flexible members have a greater thickness to provide additional strength.

16. The device according to claim 15, in which a hinge formation is provided at each respective opposite end of the formation, and parts of the flexible members adjacent the hinge formation have a greater thickness relative to the remainder of the flexible members.

17. A device according to claim 1, in which the flexible members are profiled so as to define a side recess in side edges thereof, which side recess can receive part of an item to enable engagement with the item, the flexible members are profiled so as to define a corner recess in a side edge adjacent an interconnected end, which corner recess can receive part of an item to enable engagement therewith, and a straight side edge is provided on the flexible members between the side and corner recesses, which side edge is engageable with control buttons to operate same.

18. (canceled)

19. (canceled)

20. The device according to claim 17, in which the straight side edge is of a size to be engageable with a single control button at a time.

21. The device according to claim 1, in which inner surfaces of the flexible members are profiled so as to facilitate gripping of an item.

22. The device according to claim 1, in which outer surfaces of the flexible member are profiled to facilitate holding of the device.

23. The device according to claim 22, in which selective parts only of the outside surfaces of the device are profiled.

24. The device according claim 1, in which a clip is provided on the device to permit mounting on an item or on clothing, the clip comprising a resilient member defining a variable size gap between the clip and the outer side of a one of the flexible members, in which gap an item or an article of clothing can be gripped, and the clip being removably mounted on the remainder of the device.

25. (canceled)

26. (canceled)

27. The device according to claim 1, in which a magnet configuration is provided to urge the flexible members together when in a rest condition.

28. The device according to claim 1, in which a formation is provided on the device to receive a line means to enable the device to be carried around a person's neck or to be secured to another device.

29. (canceled)

30. (canceled)
